(19) United States
(12) Patent Application Publication
(10) Pub. No.: US 2007/0274688 A1
(43) Pub. Date: Nov. 29, 2007

(54) Moving image playback apparatus, moving image playback method, and moving image recording medium

(75) Inventors: Noriaki Kitada, Tokorozawa-shi (JP); Kosuke Uchida, Ome-shi (JP); Satoshi Hoshina, Ome-shi (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba

(21) Appl. No.: 11/601,495

(22) Filed: Nov. 17, 2006

(30) Foreign Application Priority Data
May 29, 2006 (JP) 2006-148026

(51) Int. Cl. H04N 7/26

(52) U.S. Cl. 386/112

(57) ABSTRACT

According to one embodiment, a moving image playback apparatus has a structure wherein a decoder is initialized when a CPU first detects an SPS-equipped I-picture in playback of a video stream of an HD DVD, and the decoder decodes the video stream.

### CROSS-REFERENCE TO RELATED APPLICATIONS

This application is based upon and claims the benefit of priority from Japanese Patent Application No. 2006-148026, filed May 29, 2006, the entire contents of which are incorporated herein by reference.

### BACKGROUND

1. Field

One embodiment of the invention relates to an H.246 moving image playback technique, in particular, a moving image playback apparatus, a moving image playback method and a program, which enables start of playback in the middle of a stream.

2. Description of the Related Art

In a technique relating to video streams in H.264 form used in HD DVDs (High Definition DVD), as disclosed in Jpn. Pat. Appln. KOKAI Pub. No. 2005-348314, it is set by the standard that an IDR (Instantaneous Decoding Refresh) picture (attribute indicating initializing the state of a decoder) for initializing a decoder is inserted in one position at least at the start of an HD DVD. To play back video streams, it is required to initialize the decoder on the basis of the IDR picture. However, in the case of special playback other than playback from the start of the DVD disk, such as the case of playing back the disk in the middle of video streams, there are cases where no IDR pictures exist, and the disk cannot be played back. To deal with the problem, as disclosed in Jpn. Pat. Appln. KOKAI Pub. No. 2005-348314, there is a technique wherein a map associating IDR pictures with playback time information, and random access to video streams is enabled by referring to the map.

However, in the above technique, it is necessary to prepare a map associating IDR pictures with playback time information each time an HD DVD is played back, and a complicated processing and time are required.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic diagram of a moving image playback apparatus according to an embodiment of the present invention, and a monitor being a display device connected to the moving image playback apparatus.

FIG. 2 is a block diagram illustrating a configuration of a main part of the moving image playback apparatus according to the embodiment of the present invention.

FIG. 3 is an exemplary schematic diagram illustrating a functional structure of a software decoder achieved by a moving image playback application program.

FIG. 4 is an exemplary schematic diagram illustrating a data structure of a video stream of H.264/AVC standard used in an HD DVD.

FIG. 5 is an exemplary schematic diagram illustrating a data structure of a GOVU.

FIG. 6 is an exemplary flowchart illustrating a flow of a moving image playback method, to which the moving image playback apparatus of the present invention is applied.

### DETAILED DESCRIPTION

Various embodiments according to the invention will be described hereinafter with reference to the accompanying drawings. In general, according to one embodiment of the invention, a moving image playback apparatus includes playback means for playing back a video stream, initializing means for initializing a decoder when an I-picture following SPS information is first detected in playback of the video stream by the playback means, and decoding means for decoding the video stream by the decoder after the initializing means initializes the decoder.

In the following description, certain terminology is used to describe features of the invention. For example, “software” is generally considered to be executable code such as an application, an applet, a routine or even one or more executable instructions stored in a storage medium. The “storage medium” may include, but is not limited or restricted to a programmable electronic circuit, a semiconductor memory device inclusive of volatile memory (e.g., random access memory, etc.) and non-volatile memory (e.g., programmable and non-programmable read-only memory, flash memory, etc.), an interconnect medium, a hard drive, a portable memory device (e.g., floppy diskette, a compact disk “CD”, digital versatile disc “DVD”, a digital tape, a Universal Serial Bus “USB” flash drive), or the like.

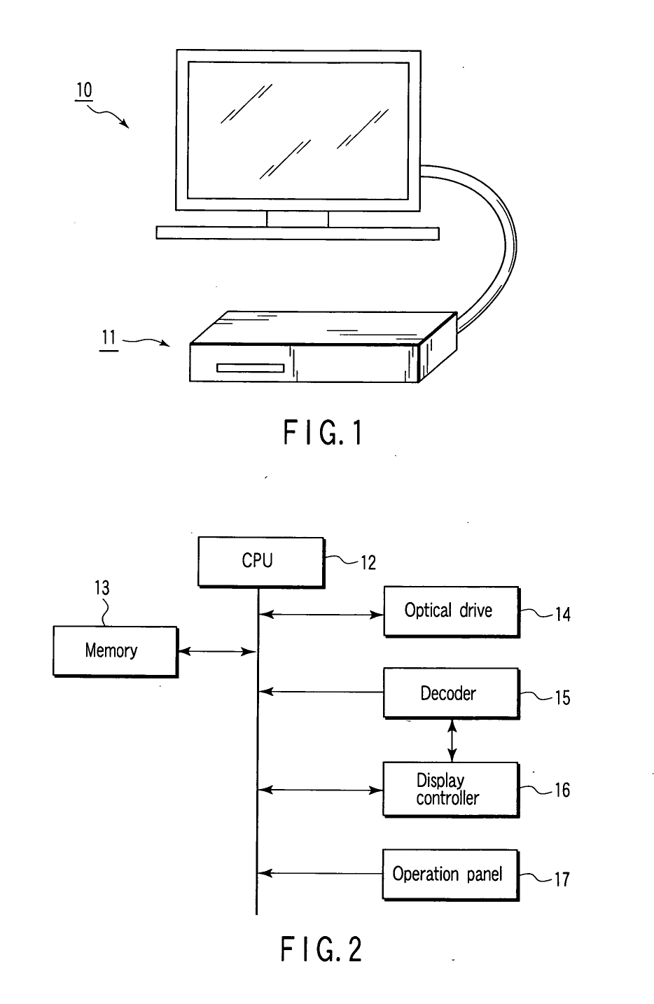

FIG. 1 is a schematic diagram illustrating a moving image playback apparatus according to an embodiment of the present invention, and a monitor 10 being a display device connected to the moving image playback apparatus. The moving image playback apparatus is realized as, for example, a player 11 adopting an HD DVD system. One embodiment of the present invention is a technique enabling special playback, such as playback starting midway through a video stream, in playing back a video stream of H.264/AVC standard such as an HD DVD.

FIG. 2 is a block diagram illustrating a configuration of a main part of the moving image playback apparatus according to the embodiment of the present invention.

The player 11 comprises a CPU (Central Processing Unit) 12, a memory 13, an optical drive 14 such as an HD DVD drive, a decoder 15 for video streams such as H.264/AVC, a display controller 16 which controls video streams output to the monitor 10, and an operation panel 17 which performs operations such as playback and fast-forwarding of the player 11.

The CPU 12 is a processor which controls the operation of the player 11, and executes various programs (an operating system, a moving image playback application program) loaded into the memory 13.

The decoder 15 is, for example, a moving image playback application program, and software for decoding and playing back compressed and encoded moving image data. The moving image playback application program is an H.264/AVC-compliant software decoder. The moving image playback application program has a function for decoding moving image streams (such as video contents of HD (High Definition) standard read by an optical disk drive) compressed and encoded by an encoding method defined by the H.264/AVC standard.

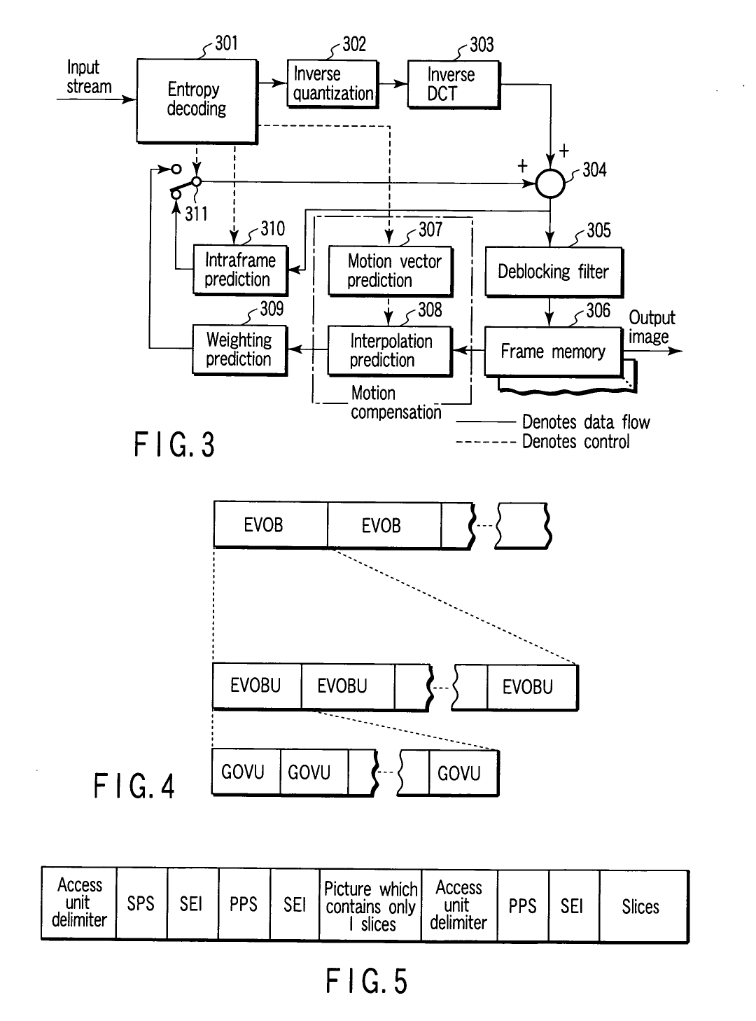

Next, explained is a functional structure of the software decoder realized by the moving image playback application program, with reference to FIG. 3.

The moving image playback application program is compliant with the H.264/AVC standard. As shown in FIG. 3, the moving image playback application program includes an entropy decoding section 301, an inverse quantization section 302, an inverse DCT section (DCT: Discrete Cosine Transform) 303, an adding section 304, a deblocking filter section 305, a frame memory 306, a movement vector predicting section 307, an interpolation predicting section 308, a weighting predicting section 309, an intraframe predicting section 310, and a mode selection switch section 311. Although orthogonal transformation of H.264 is performed with precision of integer and is different from a conventional DCT, it is referred to as DCT in this explanation.

Encoding of each picture is performed in macroblocks of 16×16 pixels. One of an intraframe encoding mode (intraframe encoding mode) and movement compensation interframe prediction encoding mode (interframe encoding mode) is selected for each macroblock.

In the movement compensation interframe prediction encoding mode, movement from an already encoded picture is estimated, and thereby a movement compensation interframe predicting signal corresponding to a picture to be encoded is generated with a predetermined form and unit. Then, a prediction difference signal obtained by subtracting the movement compensation interframe predicting signal from the picture to be encoded is encoded by orthogonal transformation (DCT), quantization, and entropy encoding. Further, in the intraframe encoding mode, a prediction signal is generated from the picture to be encoded, and the prediction signal is encoded by orthogonal transformation (DCT), quantization, and entropy encoding.

To further enhance the compressibility, a codec compliant with the H.264/AVC standard uses the following techniques:

(1) movement compensation with a pixel precision (¼ pixel precision) higher than that of conventional MPEG;

(2) intraframe prediction for efficiently performing intraframe encoding;

(3) deblocking filter to reduce block distortion

(4) integer DCT in units of 4×4 pixels;

(5) multi-reference frame which enables use of a plurality of pictures at desired positions as reference pictures; and

(6) weighting prediction.

The following is explanation of operation of the software decoder illustrated in FIG. 3.

A moving image stream compressed and encoded in accordance with the H.264/AVC standard is input to the entropy decoding section 301. The compressed and encoded moving image stream includes, besides the encoded image information, movement vector information used for the movement compensation interframe prediction encoding (interframe prediction encoding), intraframe predicting information used for intraframe prediction encoding (intraframe prediction encoding), and mode information indicating the prediction mode (interframe prediction encoding/intraframe prediction encoding), etc.

Decoding is performed in units of, for example, macroblocks of 16×16 pixels. The entropy decoding section 301 subjects the moving image stream to entropy decoding such as variable-length decoding, and separates a quantizing DCT coefficient, the movement vector information (movement vector difference information), the intraframe predicting information, and the mode information from the moving image stream. For example, each macroblock in the picture to be decoded is subjected to entropy decoding in 4×4 pixel blocks (or 8×8 pixel blocks), and each block is converted into a quantizing DCT coefficient of 4×4 pixels (or 8×8 pixels). In the following explanation, suppose that each block is formed of 4×4 pixels. The movement vector information is transmitted to the movement vector predicting section 307. The intraframe predicting information is transmitted to the intraframe predicting section 310. The mode information is transmitted to the mode selection switch section 311.

Each quantizing DCT coefficient of 4×4 pixels of each block to be decoded is converted into a 4×4 pixel DCT coefficient (orthogonal transformation coefficient) by inverse quantization by the inverse quantizing section 302. Each 4×4 pixel DCT coefficient is converted from frequency information into a 4×4 pixel value by inverse integer DCT (inverse orthogonal transformation) by the inverse DCT section 303. Each 4×4 pixel value is a prediction error signal corresponding to the block to be decoded. The prediction error signal is transmitted to the adding section 304. In the adding section 304, a prediction signal (movement compensation intraframe prediction signal or intraframe prediction signal) is added to the prediction error signal, and thereby the 4×4 pixel value corresponding to the block to be decoded is decoded.

In the intraframe predicting mode, the mode selection switch section 311 selects the intraframe predicting section 310, and thereby the intraframe prediction signal from the intraframe predicting section 310 is added to the prediction error signal. In the interframe predicting mode, the mode selection switch section 311 selects the weighting predicting section 309, and thereby the movement compensation interframe predicting signal obtained by the movement vector predicting section 307, the interpolation predicting section 308, and the weighting predicting section 309 is added to the prediction error signal.

As described above, a process of decoding the picture to be decoded by adding a prediction signal (movement compensation interframe prediction signal or intraframe prediction signal) to the prediction error signal corresponding to the picture to be decoded is performed in predetermined blocks.

Each decoded picture is subjected to deblocking filtering by the deblocking filter section 305, and thereafter stored in the frame memory 306. The deblocking filter section 305 subjects each decoded picture in units of 4×4 pixel block to deblocking filtering to reduce block noises. The deblocking filtering prevents block distortion from being included in a reference image and thereby being propagated to a decoded image. Throughput for the deblocking filtering is enormous, and sometimes constitutes 50% of the whole throughput of the software decoder. The deblocking filtering is adaptively performed such that stronger filtering is performed in a part where block distortion easily occurs and weaker filtering is performed in a part where block distortion does not often occurs. The deblocking filtering is realized by loop filtering.

Each picture subjected to deblocking filtering is read as an output image frame (or output image field) from the frame memory 306. Further, each picture (reference picture) to be used as a reference image for movement compensation interframe prediction is stored for a predetermined period of time in the frame memory 306. In movement compensation interframe prediction encoding of the H.264/AVC standard, a plurality of pictures can be used as reference pictures. Therefore, the frame memory 306 includes a plurality of frame memory portions to store images of a plurality of pictures.

The movement vector predicting section 307 generates movement vector information on the basis of the movement vector difference information corresponding to each block to be decoded. The interpolation predicting section 308 generates a movement compensation interframe prediction signal from pixel groups of integer precision and prediction interpolating pixel groups with ¼ pixel precision in the reference picture, on the basis of the movement vector information corresponding to each block to be decoded. In generation of prediction interpolating pixels with ¼ pixel precision, a ½ image is generated first by using a 6-tap filter (with 6 inputs and 1 input), and then a 2-tap filter is used to obtain it. Therefore, it is possible to perform a prediction interpolating with high precision in view of high-frequency components, although much throughput is required to perform movement compensation.

The weighting predicting section 309 generates a weighted movement compensation interframe predicting signal, by multiplying a movement compensation interframe predicting signal by a weight coefficient for each movement compensation block. The weighting prediction is a prediction of brightness of the picture to be decoded. The weighting prediction improves the image quality of an image whose brightness changes with lapse of time, such as fade-in and fade-out. However, the throughput necessary for software decoding is increased by the prediction.

The intraframe predicting section 310 generates, from a picture to be decoded, an intraframe prediction signal of a block to be decoded included in the picture. The intraframe predicting section 310 performs intrapicture prediction in accordance with the above intraframe prediction information, and generates an intraframe prediction signal from a pixel value of an already decoded block which exists in the same picture as that of the block to be decoded and is adjacent to the block to be decoded. The intraframe prediction is a technique of enhancing the compressibility by using pixel correlation between blocks. In the intraframe prediction, if each block is formed of, for example, 16×16 pixels, one of four prediction modes is selected for each intraframe prediction block, in accordance with the intraframe prediction information. The four prediction modes are vertical prediction (prediction mode 0), horizontal prediction (prediction mode 1), mean value prediction (prediction mode 2), and plane prediction (prediction mode 3). Although the plane prediction is selected with less frequency than those of the other intraframe prediction modes, the plane prediction requires throughput more than that of any other intraframe prediction mode.

Next, explained is a data structure of a video stream of the H.264/AVC standard used in HD DVDs, with reference to FIG. 4.

A video stream of the H.264/AVC standard used in HD DVDs is formed of a plurality of EVOBs. Further, in the standard of HD DVDs, the first picture in an EVOB is an IDR (Instantaneous Decoding Refresh) picture. In the H.264/AVC standard used in HD DVDs, there are cases where an IDR picture exists only in one position in a HD DVD. When a video stream recorded on an HD DVD is played back, it is necessary to read the IDR picture first to initialize the decoder. Further, each EVOB is formed of a plurality of EVOBUs, and each EVOBU is formed of a plurality of GOVUs.

FIG. 5 is a schematic diagram illustrating a data structure of GOVU. Each GOVU includes an I-picture with SPS (Sequence Parameter Set) (which is referred to as “Picture which contains only I slice” in FIG. 5). The term “SPS” indicates a header including information concerning encoding of the whole sequence. The term “I-picture” is a picture obtained by intrapicture independent encoding.

Further, each GOVU also includes information called Access Unit Delimiter, which indicates the type of slice included in the access unit and the like, SEI (Supplemental Enhancement Information), and information called PPS (Picture Parameter Set), which indicates the encoding mode of the whole picture. When a video stream recorded on an HD DVD is played back, it is necessary to read the IDR picture first and initialize the decoder. However, in the present invention, to deal with the case where an IDR picture exists only in the first EVOB, the I-picture with SPS, which is provided to all GOVUs, is detected first, and the apparatus initializes the decoder using the first detected I-picture with SPS as the IDR picture. Thereby, the apparatus can deal with special playback, such as the case where an IDR picture exists only at the beginning position of an HD DVD.

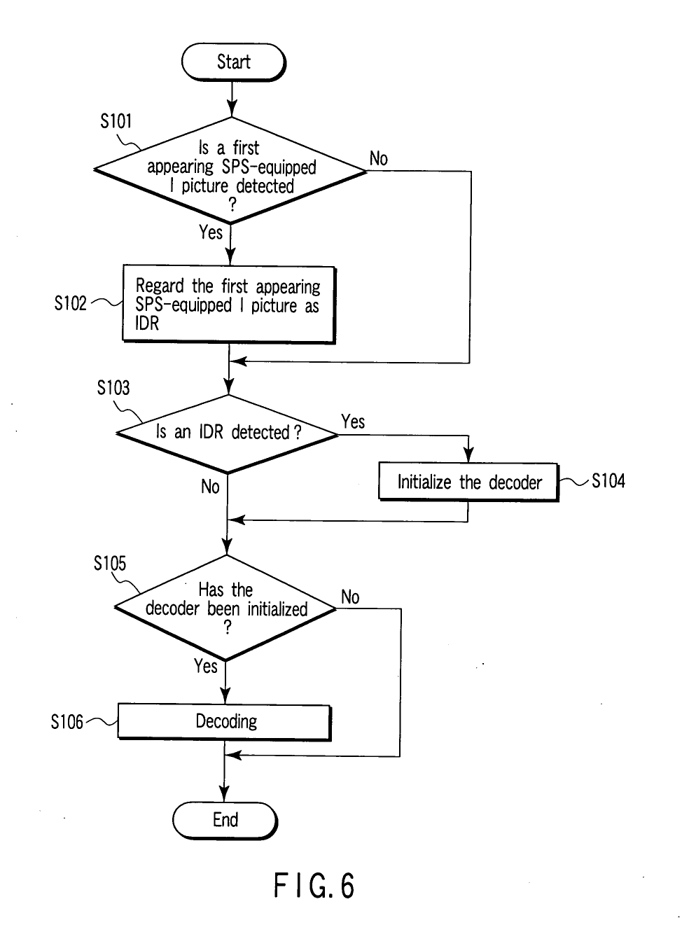

Next, explained is a moving image playback method, to which the moving image playback apparatus of the present invention is applied. FIG. 6 is a flowchart illustrating flow of the moving image playback method.

When playback of a video stream is started, the CPU 12 of the player 11 monitors whether an SPS-equipped I-picture appearing first is detected or not (block S101). In block S101, if the first appearing SPS-equipped I-picture is detected (Yes of block S101), the CPU 12 regards the first appearing SPS-equipped I-picture as an IDR picture (block S102). Specifically, when the CPU 12 detects the first appearing SPS-equipped I-picture, the CPU 12 regards the detection as detection of an IDR picture. Next, the CPU 12 determines whether an IDR picture is detected (block S103). Since detection of the first appearing SPS-equipped I-picture (Yes of block S103) in block S102 is regarded as detection of an IDR picture, the CPU 12 goes to block S104. In block S104, the CPU 12 initializes the decoder, by initializing only a reference picture buffer, on the basis of the detected first SPS-equipped I-picture.

Then, the CPU 12 determines whether the decoder has been initialized or not (block S105). If the CPU 12 has gone through block S104, the decoder has already been initialized (Yes of block S105). Thus, the CPU 12 goes to block S106, and decodes the video stream (block S106).

On the other hand, when no first appearing SPS-equipped I-picture is detected in block S101 (No of block S101), the CPU 12 goes to the block S103. When an IDR picture is detected in block S103 (Yes of block S103), the CPU 12 goes to block S104, and performs conventional decoder initialization (block S104) and decoding (block S106), in the same manner as in the conventional case of detecting an IDR picture. When an IDR picture is detected without the processing of block S102 (No of block S101 and Yes of block S103), the CPU 12 initializes the reference picture buffer, the frame number, and the picture output order, etc.

On the other hand, when no IDR picture is detected in block S103 (No of block S103), the CPU 12 goes to block S105. In this case, since the decoder has not been initialized (No of block S105), the processing is ended without performing decoding.

As a modification of the above embodiment, the decoder may be initialized and the decoding may be performed when one of a first appearing SPS-equipped I-picture and an IDR picture is detected.

As detailed above, according to the present invention, even when no IDR picture is detected, it is regarded that an IDR picture is detected when a first SPS-equipped I-picture, which is provided to each GOVU, is detected, in addition to the conventional case of detecting an IDR picture. Therefore, random playback of a video stream is easily performed.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An apparatus comprising:
a processor adapted to playback a video stream, and initialize a decoder when an I-picture following Sequence Parameter Set (SPS) information is detected as appearing first in playback of the video stream; and
a decoder in communication with the processor, the decoder to decode the video stream after initialization.

2. An apparatus according to claim 1, wherein processor, during playback the video stream, to consider the first detected I-picture with the SPS information as an Instantaneous Decoding Refresh (IDR) picture indicating that a state of the decoder is to be initialized.

3. An apparatus according to claim 2, wherein processor to initialize the decoder up detecting the I-picture with the SPS information and considering the I-picture as being equivalent to the IDR picture.

4. An apparatus according to claim 1 further comprising a reference picture buffer that is initialized upon initialization of the decoder.

5. An apparatus according to claim 1 operating in accordance with H.264/AVC standard.

6. A method comprising:
initializing a decoder when an I-picture following Sequence Parameter Set (SPS) information is first detected in playback of a video stream; and
decoding the video stream by the decoder.

7. A method according to claim 6, wherein the video stream includes an attribute indicating that a state of the decoder is to be initialized.

8. A method according to claim 7, wherein the initializing of the decoder when one of (i) the first appearing I-picture following the SPS information and (ii) the attribute indicating the state of the decoder is detected.

9. A method according to claim 8, wherein the first appearing I-picture following the SPS information is regarded as an Instantaneous Decoding Refresh (IDR) picture.

10. A method according to claim 6, wherein the attribute indicating that the state of the decoder is to be initialized is an Instantaneous Decoding Refresh (IDR) picture.

11. A storage medium to store a program executed by a processor in order to perform the following operations:
playback of a video stream;
initializing a decoder when I-picture following Sequence Parameter Set (SPS) information is first detected in playback of the video stream; and
decoding the video stream after the decoder is initialized.

12. A storage medium according to claim 11, wherein the initializing of the decoder is performed upon detection of the I-picture following the SPS information at a beginning of the video stream and considering the I-picture as an Instantaneous Decoding Refresh (IDR) picture.

13. A storage medium according to claim 11 being implemented within a digital video disk (DVD) player.
